(19) United States
(12) Patent Application Publication
(10) Pub. No.: US 2009/0250852 A1
(43) Pub. Date: Oct. 8, 2009

(54) HYDRAULICALLY DAMPED MOUNTING DEVICE

(75) Inventors: Alun Jones, Westbury (GB); Richard David Edward Johnson, Trowbridge (GB)

Correspondence Address: MCGARRY BAIR PC, 32 Market Ave. SW, SUITE 500, GRAND RAPIDS, MI, 49503, US

(73) Assignee: DTR VMS LIMITED, Chippenham (GB)

(21) Appl. No.: 12/417,324

(22) Filed: Apr. 2, 2009

(30) Foreign Application Priority Data
Apr. 3, 2008 (GB) 0806073.3

(51) Int. Cl. F16F 13/00

(52) U.S. Cl. 267/140.13

(57) ABSTRACT

A hydraulically damped mounting device has two anchor parts connected by deformable wall. A partition is associated with one of the anchor parts and defines, together with the deformable wall a working chamber for hydraulic fluid. The working chamber is connected via a passageway to a compensation chamber partially bounded by another deformable wall. The partition separates the working and compensation chambers, and the device has a diaphragm being a barrier between the hydraulic fluid and a gas. In one arrangement at least part of the passageway is formed within a cavity in the partition in which there are projections which are arranged to overlap, and so define a convoluted path for the hydraulic fluid around the projections. In another arrangement a duct to a diaphragm part is at least partially formed by a cavity within the partition, which cavity has cylindrical projections arranged one within the other and overlapping to form a convoluted path for hydraulic fluid. In a third arrangement the passageway has a branch to the diaphragm, which branch is convoluted as it passages through a cavity in the partition containing cylindrical projections.

### CROSS-REFERENCE TO RELATED APPLICATIONS

This application claims priority on British Application No. GB0806073.3, filed Apr. 3, 2008.

### BACKGROUND OF THE INVENTION

1. Field of the Invention

The present invention relates to a hydraulically damped mounting device. Such a device usually has a pair of chambers for hydraulic fluid, connected by suitable passageway, and damping is achieved due to the flow of fluid through that passageway.

2. Summary of the Prior Art

EP-A-0115417 and EP-A-0172700 discussed two different types of hydraulically damped mounting devices for damping vibration between two parts of a piece of machinery, e.g. a car engine and a chassis. EP-A-0115417 disclosed various “cup and boss” type of mounting devices, in which a “boss”, forming one anchor part to which one of the pieces of machinery was connected, was itself connected via a deformable (normally resilient) wall to the mouth of a “cup”, which was attached to the other piece of machinery and formed another anchor part. The cup and the resilient wall then defined a working chamber for hydraulic fluid, which was connected to a compensation chamber by a passageway (usually elongate) which provided the damping orifice. The compensation chamber was separated from the working chamber by a rigid partition, and a flexible diaphragm was in direct contact with the liquid and, together with the partition formed a gas pocket.

In EP-A-0172700 the mounting devices disclosed were of the “bush” type. In this type of mounting device, the anchor part for one part of the vibrating machinery is in the form of a hollow sleeve with the outer anchor part in the form of a rod or tube extending approximately centrally and coaxially of the sleeve. In EP-A-0172700 the tubular anchor part was connected to the sleeve by resilient walls, which defined one of the chambers in the sleeve. The chamber was connected via a passageway to a second chamber bounded at least in part by a bellows wall which was effectively freely deformable so that it could compensate for fluid movement through the passageway without itself resisting that fluid movement.

In the hydraulically damped mounting devices disclosed in the specifications discussed above, there was a single passageway. It is also known, from other hydraulically damped mounting devices, to provide a plurality of independent passageways linking the chambers for hydraulic fluid.

In EP-A-0115417, there was a single diaphragm, which was configured to give a specific influence on the vibration characteristics of the hydraulically damped mounting device. Those characteristics depended on the stiffness of the diaphragm, by which is meant the change in applied pressure needed to cause unit change in the volume displaced by the diaphragm. Furthermore, the surface of the diaphragm which is in contact with the fluid in the working chamber may be covered by a snubber plate, with openings therein for fluid communication therethrough between the upper surface of the diaphragm and the rest of the working chamber, and it has been found that the size of those openings also affects the characteristics of the mount.

In GB-A-2282430, a mounting device was disclosed of the “cup and boss” type, with two diaphragms. The two diaphragms were arranged to have different characteristics, such as different stiffnesses or different effective stiffnesses, due to the shape of the openings by which fluid reaches those diaphragm parts from the working chamber. GB-A-2282430 also disclosed that either or both of the diaphragms may be convoluted.

One issue when producing a mount of the “cup and boss” type is to ensure that the characteristics of the passageway are appropriate. Normally, the passageway is formed in a rigid partition separating the working and compensation chambers, and thus there is limited space available within that partition for the passageway. In general, in the arrangements disclosed in EP-A-0115417 and GB-A-2282430, the passageway was formed as a spiral within the partition.

### SUMMARY OF THE INVENTION

The present invention, at its most general, seeks to modify such passageway arrangements, and, in a first aspect, proposes that at least part of the passageway is formed within a cavity in the partition in which there are projections which are arranged to overlap, and so define a convoluted path for the hydraulic fluid around the projections.

Thus, according to the first aspect, there may be provided a hydraulically damped mounting device comprising two anchor parts connected by a deformable wall; a working chamber enclosed between the deformable wall and a partition rigidly associated with a first one of the anchor parts, the working chamber containing hydraulic fluid; a compensation chamber for the hydraulic fluid, the compensation chamber being at least partially bounded by a second deformable wall; a passageway between the chambers to allow fluid communication between them; and a flexible diaphragm part acting as a barrier between the hydraulic fluid and at least one gas chamber, wherein the passageway is formed in a rigid partition separating the working and compensation chambers, the partition has a hollow cavity therein having opposed surfaces defining part of the passageway therebetween, each of the opposed surfaces having a projection extending therefrom towards the other of the opposed surfaces, the free end of each projection being spaced from the surface towards which it extends, the free end of each projection being closer to the surface towards which it extends then the free end of the projection extending from the surface, whereby the projections overlap and define a convoluted path for the passageway around the projections.

In the first aspect, therefore, the projections form convolutions in the passageway linking the working and compensation chambers. However, similar ideas may be applied to other fluid parts in the mounting device. For example, they may be used in a path from the working and/or compensation chamber to a diaphragm part, or to one or more diaphragm parts where there are multiple diaphragm parts.

Thus, according to a second aspect, at its most general, a duct to a diaphragm part is at least partially formed by a cavity within the partition, which cavity has cylindrical projections arranged one within the other and overlapping to form a convoluted path for hydraulic fluid.

Thus, according to this second aspect, there may be provided a hydraulically damped mounting device comprising two anchor parts connected by a deformable wall; a working chamber enclosed between the deformable wall and a partition rigidly associated with a first one of the anchor parts, the working chamber containing hydraulic fluid; a compensation chamber for the hydraulic fluid, the compensation chamber being at least partially bounded by a second deformable wall; a passage way between the chambers to allow fluid communication between them; and a flexible diaphragm part acting as a barrier between the hydraulic fluid and at least one gas chamber, wherein there is a duct for hydraulic fluid formed in a rigid partition separating the working and compensation chambers, and supporting the diaphragm part, the partition having a hollow cavity therein having opposed surfaces defining part of the duct therebetween, each of the opposed surfaces having a projection extending therefrom towards the other of the opposed surfaces, the free end of each projection being spaced from the surface towards which it extends, the free end of each projection being closer to the surface towards which it extends then the free end of the projection extending from the surface, the duct extending to said diaphragm part from said working or compensation chamber, the duct extending through said cavity, whereby said duct is convoluted around the projections.

A third possibility is for the passageway linking the working and compensation chambers, and the duct for hydraulic fluid from the working and/or compensation chamber to the diaphragm part be linked together. In such an arrangement, the duct to the diaphragm part may be a branch in the passageway linking the working and compensation chambers. Then, in a third aspect of the invention, that branch may be made convoluted, by causing it to pass through the cavity containing the cylindrical projections.

Thus, according to a third aspect of the invention, there may be provided a hydraulically damped mounting device comprising two anchor parts connected by a deformable wall; a working chamber enclosed between the deformable wall and a partition rigidly associated with a first one of the anchor parts, the working chamber containing hydraulic fluid; a compensation chamber for the hydraulic fluid, the compensation chamber being at least partially bounded by a second deformable wall; a passage way between the chambers to allow fluid communication between them; and a flexible diaphragm part acting as a barrier between the hydraulic fluid and at least one gas chamber, wherein the passageway is formed in a rigid partition separating the working and compensation chambers, the partition has a hollow cavity therein having opposed surfaces, each of the opposed surfaces having a projection extending therefrom towards the other of the opposed surfaces, the free end of each projection being spaced from the surface towards which it extends, the free end of each projection being closer to the surface towards which it extends then the free end of the projection extending from the surface, wherein said passageway has a branch extending therefrom into said cavity, and from said cavity to said diaphragm part, whereby said branch of said passageway is convoluted around said projections.

Thus, in all of the above aspects, fluid passing through the cavity has to flow around the projections. In normal operation, where the mounting device vibrates vertically, it is convenient if the flow through the cavity is in the radial (horizontal) directions with the upwardly extending projection acting as a weir, and the downwardly extending projection acting as an underfall, for the fluid flow. Moreover, the discussion of the three aspects of the invention above refers to one projection extending from each opposed surface bounding the cavity, there may be additional projections extending from either or both of those surfaces. In such case, the projections form a series of weirs and underfalls for the fluid flow.

Where, as in the first aspect, the cavity is part of the passageway between the working and compensation chambers, it may be convenient for the inlet from the working or compensation chamber within a radial or central position within that cavity, and for the outlet (to the compensation chamber or working chamber) to be at the periphery of the cavity. In such an arrangement, it may be then convenient if projections are cylindrical, one within the other. However, such an arrangement is not limited to the case where such cylinders are circular in cross-section. Other cross-sectional shapes may be possible, such as square, rectangular, or oval. Preferably, the cylindrical projections are concentric, although this is not essential. Moreover, although we have referred to the projections being cylindrical, their walls need not be parallel to their axes so that the projections are inclined to the surfaces from which they extend. In further alternatives, the projection may be linear or curved walls within the cavity.

In a similar way, where the cavity is part of a duct or branch leading to a diaphragm, the opening from the cavity to that diaphragm may be at a central part of the cavity, and the inlet to the cavity be at a peripheral part. Again, in such an arrangement, it may be convenient to use cylindrical projections to define weirs and underfalls although the other shapes of projection discussed above may also be used.

To form the cavity, it may be possible to use selective laser sintering to form a one-piece partition with the cavity therein. However, for ease of manufacture, it may be preferable for the partition to comprise at least two partition parts, with the cavity being formed between those partition parts.

As was discussed above, in all three aspects of the invention, the diaphragm part acts a barrier between hydraulic fluid and a gas chamber. Means, such as a vacuum source, may be connected to that gas chamber to allow the gas therefrom to be evacuated. This forces the diaphragm against a wall of the vacuum chamber, and prevents the diaphragm from vibrating. Under such conditions, the hydraulic fluid in the duct or branch leading to that diaphragm part also cannot move, and the branch or duct is effectively blocked off. Thus, by application of vacuum to the gas chamber, the effect of the fluid movement in the duct or branch, and the vibration of the diaphragm, may be turned on and off.

Moreover, in the second and third aspects of the invention, where the diaphragm part terminates the duct or branch, a further diaphragm part may be provided, preferably on the partition, which acts as a barrier between the fluid in the working chamber and a further gas pocket. Again, means such as a vacuum source may be connected to that further gas pocket, to allow it to be evacuated. In such an arrangement, by selectively applying a vacuum to the gas pocket or further gas pocket, the characteristics if the mounting device may be changed.

In all the aspects discussed above, the or any diaphragm part may be annular. Such an annular diaphragm may be an incomplete annulus similar to a horse shoe, with a gap therein, to enable other components such as the passageway, to be in the gap of the annulus.

Where, as in the first aspect of the invention, the passageway is convoluted around the projections, the inlet to that passageway may be provided within the innermost cylindrical projection, and the outlet lie outside the outermost cylindrical projection. Where, as in the second or third aspect, the convolutions are in a duct or branch to the diaphragm part, the inlet to that duct or branch may be outside the outermost cylindrical projection, and the outlet to the diaphragm part be within the innermost cylindrical projection.

Embodiments of the present invention will now be described in detail, by way of example, with reference to the accompanying drawings, in which:

### BRIEF DESCRIPTION OF THE DRAWINGS

FIG. 1 is a cross-sectional view of a hydraulically damped mounting device being a first embodiment of the present invention;

FIG. 2 is a cross-sectional view of the partition of the mounting device of FIG. 1;

FIG. 3 is a perspective view from below of the partition of FIG. 2;

FIG. 4 is a view from below of the partition of FIG. 2;

FIG. 5 is a perspective view from above of the partition of FIG. 2;

FIG. 6 is a cross-sectional view of a hydraulically damped mounting device being a second embodiment of the present invention;

FIG. 7 is a cross-sectional view through the partition of the hydraulically damped mounting device of FIG. 6;

FIG. 8 is a perspective view, partially in section, of the partition of FIG. 7;

FIG. 9 is a view from below of the partition of FIG. 7;

FIG. 10 is a cross-sectional view from a hydraulically damped mounting device being a third embodiment of the present invention;

FIG. 11 is a cross-sectional view through the partition of the hydraulically damped mounting device of FIG. 10;

FIG. 12 is a perspective view, partially in section, of the partition of FIG. 11;

FIG. 13 is a view from below of the partition of FIG. 11; and

FIG. 14 is a cross-sectioned view of a hydraulically damped mounting device being a fourth embodiment of the present invention.

### DETAILED DESCRIPTION

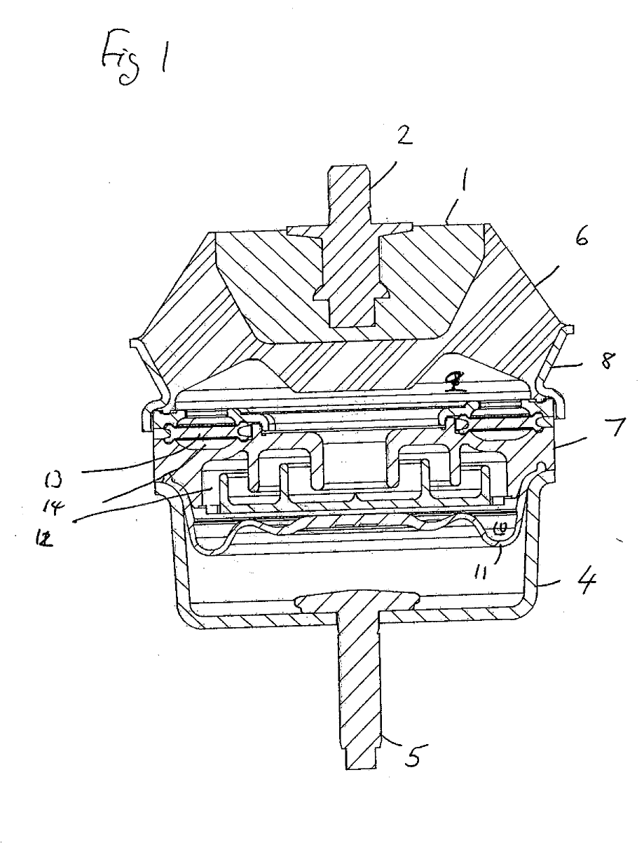

A first embodiment of the present invention will now be described with reference to FIGS. 1 to 5.

Referring first to FIG. 1, a hydraulically damped mounting device being a first embodiment of the invention is shown for damping vibration between two parts of a structure (not shown). For example, the mounting device may be used to damp vibration between a vehicle engine and a chassis of the vehicle. The mount has a boss 1 connectable via a fixing bolt 2 to one of the parts of the structure, and the other part of the structure is connectable to a generally U-shaped cup 4 via a further fixing bolt 5. A resilient spring 6 of e.g. rubber interconnects the boss 1 and cup 4. A rigid partition 7 is mounted on the cup 4 to extend across its mouth, and a bracket 8 is mounted on the partition 7, so that the spring 6 is connected to the cup 4 via the bracket 8 and the partition 7.

A working chamber 9 is defined within the mounting device, bounded by the resilient spring 6 and the partition 7. Moreover, within the cup 4, there is a compensation chamber 10 bounded by a flexible wall 11. The working chamber 9 and the compensation chamber 10 are connected by a passageway 11 within the partition 7. The configuration of that passageway 11 will be described in more detail later.

Thus, when the boss 1 vibrates relative to cup 4 (in the vertical direction in FIG. 1) the volume of the working chamber 9 will change, and hydraulic fluid in that working chamber will be forced through the passageway 12 into, or out of, the compensation chamber 10. The volume of the compensation chamber 10 needs to change in response to such fluid movement, and this is achieved by deformation of the flexible wall 11. This movement of the hydraulic fluid damps the vibrations.

In addition, the partition 7 supports an annular diaphragm 13, one side of which is in contact with the hydraulic fluid in the working chamber 9, and the other bounds a gas pocket 14.

The above structure is generally similar to that described in EP-A-0115417, and the manner of operation is similar.

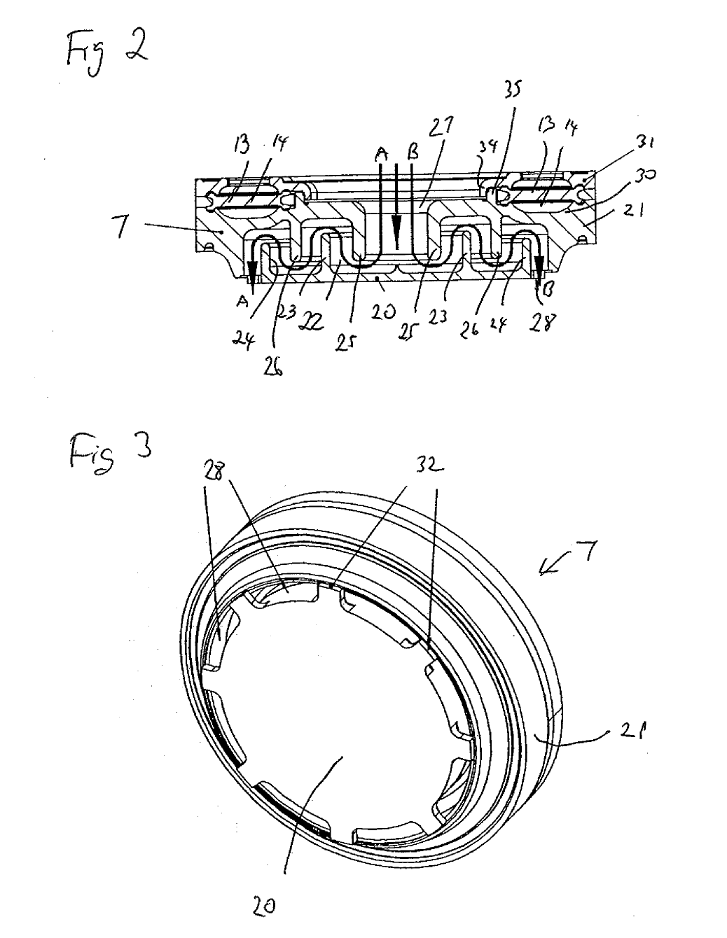

The structure of the partition 7 is illustrated in more detail in FIG. 2. The partition 7 has a lower plate 20 attached at its periphery to an upper body 21, to define a cavity 22 between the body 21 and the plate 20. The plate 20 has upstanding projections 23, 24 in the form of concentric circular cylinders. Similarly, the body 21 has downwardly extending concentric cylindrical projections 25, 26 with the projection 25 being radially inward of the projection 23, and the projection 26 being between the projections 23 and 24. The body 21 has an opening 27 within the confines of the cylindrical projection 25, which opening 27 communicates with the working chamber 9. Similarly, openings 28 are formed at the periphery of the plate 20, communicating with the compensation chamber 10. Thus, convoluted paths shown by arrows A to A and B to B are formed within the cavity 22, extending between the working chamber 9 and the compensation chamber 10. The projections 23 and 24 extending from the plate 20 extend close to, but are spaced from, the body 20, and similarly the projections 25 and 26 extend close to, but are spaced from, the plate 20. Thus, fluid must flow around those projections in order to pass from the working chamber 9 to the compensation chamber 10, or vice versa, and thus may follow a longer path than the direct distance between the openings 27 and 28.

FIG. 2 also shows that the gas pocket 14 is formed by an annular recess 30 in the upper surface of the body 21, which annular recess 30 is covered by diaphragm 13, which itself is annular. The diaphragm 13 is then held on the body 21 by a cover 31.

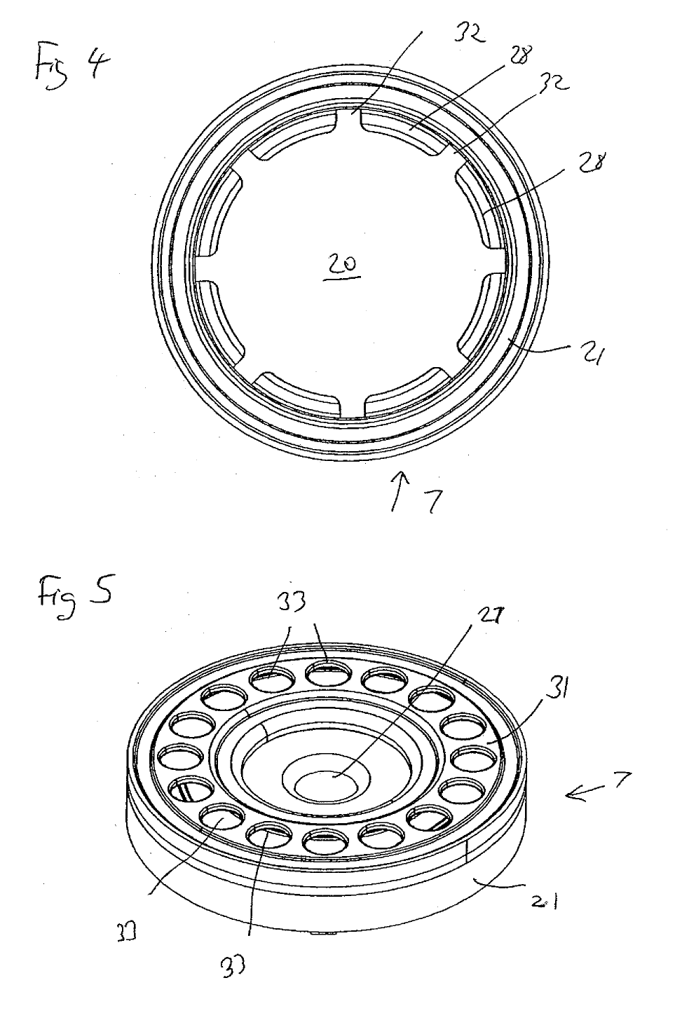

FIG. 3 shows the openings 28 at the end of the passageway 11 between the working and compensation chambers 9, 10. FIG. 3 also shows the parts 32 of the plate 20 which separate those openings 28 one from the other, and which may be bonded to the body 21 of the partition 7 by ultrasonic or other welding. Similar features are also shown in FIG. 4, which shows a bottom view of the partition 7.

Moreover, in this embodiment the flow of fluid is different from in e.g. EP-A-0115417. In that document, the passageway between the chambers is a spiral, so that the fluid flows circumferentially around the axis of vibration of the mount, as it flows outwardly. However, in the embodiment of FIG. 1, the fluid flows between the opening 27 and the multiple openings 28. Thus, the fluid flow is essentially radial, and also axial as it flows around the projections 23, 24, 25 and 26. The projections 23 and 24 act as weirs over which the fluid flows, and the projections 25 and 26 act as underfalls under which the fluid flows, to define the convoluted path. Hence, in this embodiment, the fluid flow between the working and compensation chambers 9, 10 is radial and axial relative to the axes of the vibration of the mount, rather than circumferential and radial, as in arrangements where the passageway is in the form of a spiral.

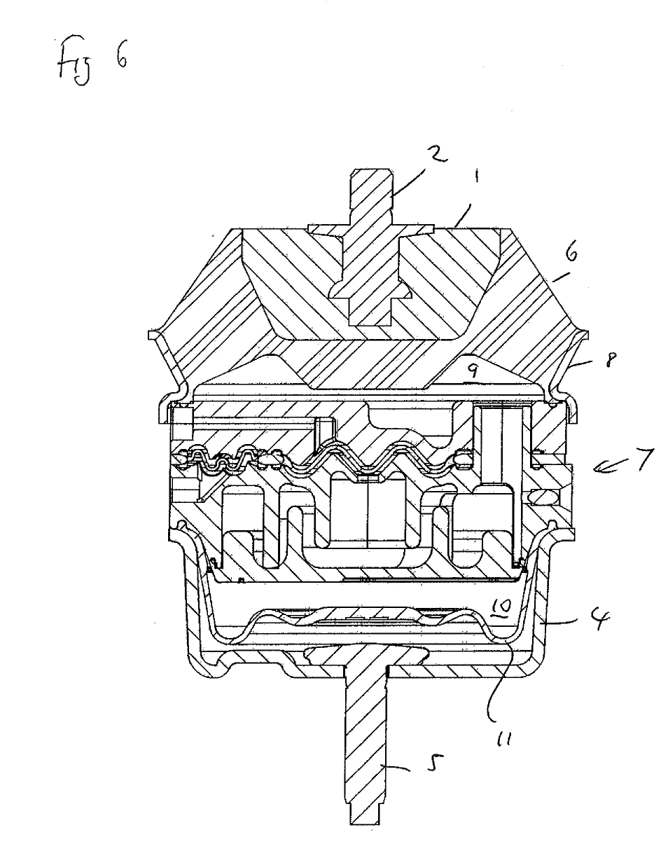

FIG. 5, which is a perspective view from above of the partition 7, shows the opening 27 by which the passageway 11 communicates with the working chamber 9, and also the cover 31 which covers the annular diaphragm 13. As can be seen from FIG. 5, that cover 31 has a series of holes 33 therein which permit fluid from the working chamber 9 to communicate with the diaphragm 13. Also, as can be seen from FIG. 2, an edge 34 of the cover 31 extends over and around an upwards projection 35 on the body 21, to seal the diaphragm 13, and the gas pocket 14, from the fluid in the working chamber 9.

A second embodiment of the invention will now be described with reference to FIGS. 6 to 10. In this embodiment, a branch in the passageway between the working and compensation chambers leads to a diaphragm. Note that components of this invention which correspond to those of the first invention are indicated by the same reference numerals, and will not be described in more detail.

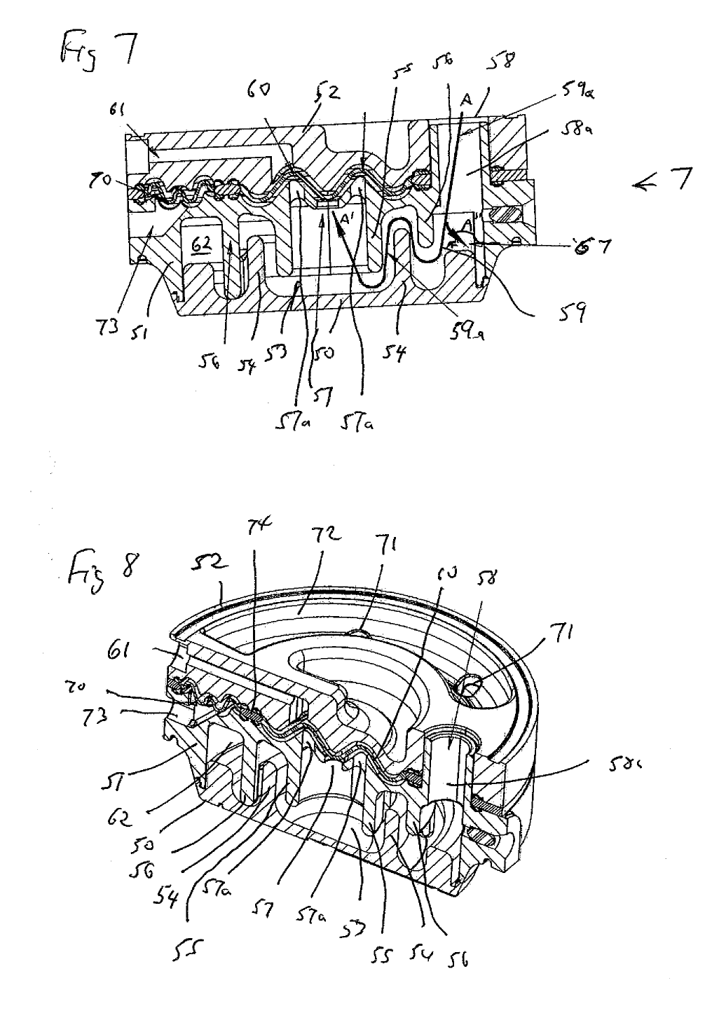

FIGS. 6 and 7 thus show the structure of the partition 7 in this embodiment. The partition 7 has a lower plate 50, a main body 51 and an upper plate 52. A cavity 53 is formed between the lower plate 50 and the body 51. A cylindrical projection 54 projects upwardly into that cavity from the lower plate 50. Similarly, cylindrical projections 55, 56 project downwardly into that cavity from the body 51. The projection 55 has its free edge uniformly spaced from the lower plate 50. However, the free edge of the projection 56 has a part (on the right in FIG. 7) which is spaced from the plate 50, and a part on (on the left in FIG. 7) which extends to make contact with the plate 50, and so seal the body 51 to the lower plate at that projection 56. The body 51 has a central opening 57 and a series of further openings around the central opening 57, within the projection 55. The body 51 also has a bore 58a which extends from an opening 58 communicating with the working chamber 9 to adjacent the cavity 53, and communicates with that cavity at a gap 59. Thus, a fluid path is defined between the working chamber 9 and the central opening 57, as shown by arrow 59a between A to A′. That path is convoluted around the projections 54, 55 and 56.

A diaphragm 60 is mounted on the body 51, lying above the central opening 57. Thus, one side of that diaphragm 60 (the lower side in FIGS. 6 and 7) is in contact with hydraulic fluid axis in the cavity 53 and the openings 57 and 57a. The upper plate 52 then covers that diaphragm 60, and holds the periphery of the diaphragm 60 in place. However, a gap is defined between the upper surface of the diaphragm 60 and the upper plate 52, which communicates with an outlet duct 61.

The bore 58a which communicates with the working chamber 9 at opening 58, also communicates with a passageway 62 extending around the partition 7, and leading to the compensation chamber.

That passageway 62 is shown more clearly in FIG. 9, which illustrates that the body 51 has a hole 63 which corresponds to the lower end of the bore 58 and a groove 64 in the lower surface of the body 51 which extends from that hole 63 around the partition 7 as shown by arrow 65 to an outlet (not shown but corresponding to the position of arrowhead 66) which opens into the compensation chamber 10. Thus, there are two possible paths from the opening 58, one path following arrow 59a leading to the diaphragm 60 (via the cavity 53) and the other leading to the compensation chamber 10 (via the groove 64). The latter is path A to A in FIG. 7 with arrow 67 showing the branching to hole 63. The path to the diaphragm 60 has a larger cross-sectional area for fluid flow than to the compensation chamber 10. Thus, the preferential liquid flow path is to the diaphragm 60, rather than that to the compensation chamber 10. Hence, assuming the diaphragm 60 is free to move in the space between the body 51 and the upper plate 52, when the boss 1 moves relative to the cup 4, fluid from the working chamber 9 is forced along the path shown by arrow A to A′ to the diaphragm, or in the opposite direction. The diaphragm 60 vibrates to absorb such fluid movement.

However, as mentioned, there is a duct 61 leading from the gas space between the diaphragm 60 and the upper plate 52, and that duct is connected to a vacuum source. When a vacuum is applied to the duct 61, the diaphragm 60 is forced against the upper plate 52, so that it is locked. The fluid in the cavity 53 therefore cannot move. As a result, if the boss 1 moves relative to the cup 2, any liquid flow must be through the passageway 62 to the compensation chamber 10. The branch from the passageway 62 to the diaphragm 60 is thus locked off when the vacuum is applied to the duct 61. Thus, the characteristics of the mounting device may be varied by applying a vacuum to that duct 61.

This may be used, for example, when the mounting device is used to damp vibration between an engine and a chassis of a vehicle. In this case, when the engine is in its “idle” state, the constant frequency low amplitude vibrations generated in that state may be absorbed by the diaphragm 60. When the engine is running to drive the vehicle, however, that idle state can be locked off, by the application of a vacuum for the duct 61.

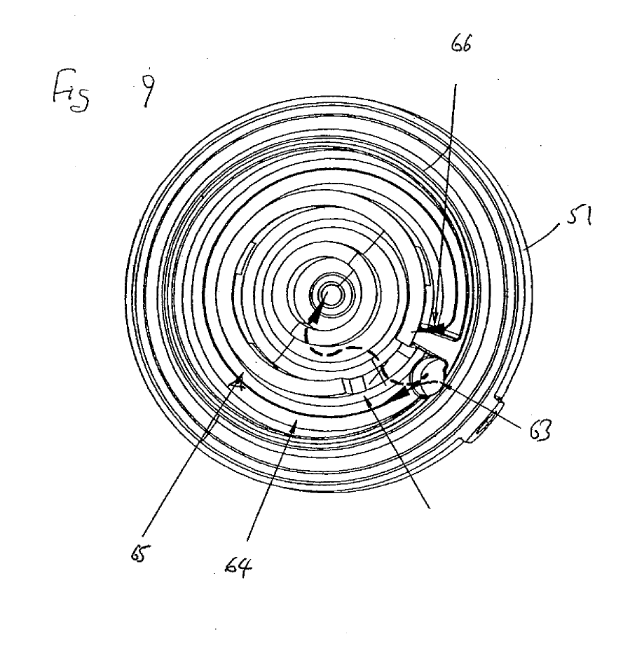

FIGS. 6 and 7 also show that there is a further diaphragm 70 mounted between the upper plate 52 and the body 51, and which communicates with the fluid in the working chamber 9 via openings 71 in a recess 72 in the upper plate 52. These are shown in FIG. 8. The diaphragm 70 thus has its upper surface in contact with hydraulic fluid from the working chamber 9. Its lower surface is exposed to a gas pocket 73 which may also be connected to a vacuum source (not shown). Thus, in e.g. the “ride” condition of the vehicle discussed above, the diaphragm 70 may absorb high frequency low amplitude vibrations due to movement of hydraulic fluid through the opening 71. However, that diaphragm 70 may be locked by the application of a vacuum to the gas chamber 73, e.g. to give an altered response in different ride conditions.

Note that, as can be seen from FIGS. 6 to 8, the projection 56 from the body 51 separates the cavity 53, which leads to the diaphragm 60, from the passageway 62 extending between the working and compensation chambers 9, 10. Moreover, FIGS. 6 to 8 show that the two diaphragms 60, 70 may be made from a single integral moulding connected at a connection 74 and held at that connection between the body 51 and the upper plate 52.

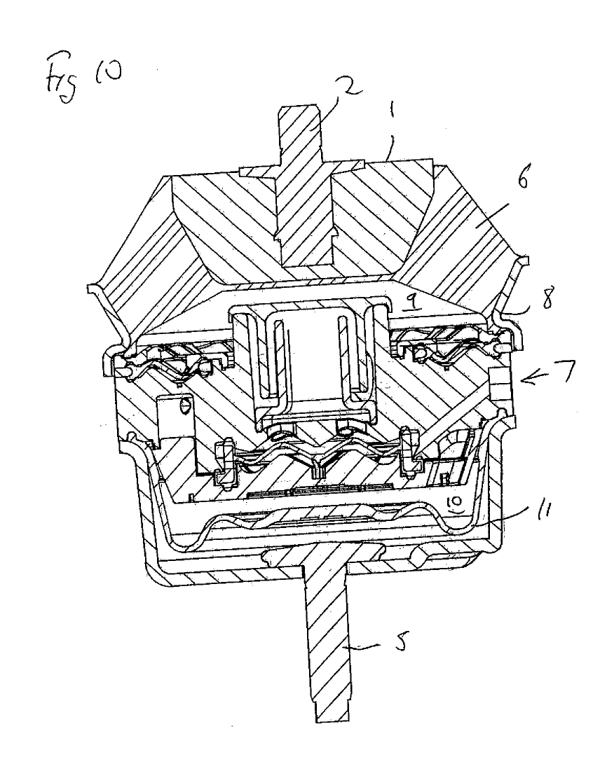

A third embodiment of the invention will now be described with reference to FIGS. 10 to 13. Again, corresponding parts are indicated by the same reference numerals. The third embodiment operates in a similar way to the second embodiment, where the passageway between the working and compensation chambers 9, 10 has a branch leading to a diaphragm. However, the structure of the partition 7 is different from that of the second embodiment.

In this third embodiment, the partition 7 has a main body 80, with a central bore 81 therein. In that bore, a cylindrical projection 82 extends upwardly, spaced from the outer walls 83 of that bore. An upper cap 84 is fitted over that bore 81, with a downward cylindrical projection 85 extending in the space between the walls 83 of the bore and the projection 82. The upper cap 84 has openings 85 therein (visible in FIG. 12) which communicate with the working chamber 9. A diaphragm 86 is then held between the body 80 and a lower plate 87, that diaphragm 86 communicating with the bore 81 via openings 88. Thus, a convoluted path is defined from the working chamber 9 to the diaphragm 86, as illustrated by arrows A to A′ and B′. This is similar to the convoluted path between the working chamber 9 and the diaphragm 60 in the second embodiment, and has a similar effect. As in the second embodiment, the gas space between the diaphragm 86 and lower plate 87 has a duct 89 leading therefrom, to a vacuum source (not shown).

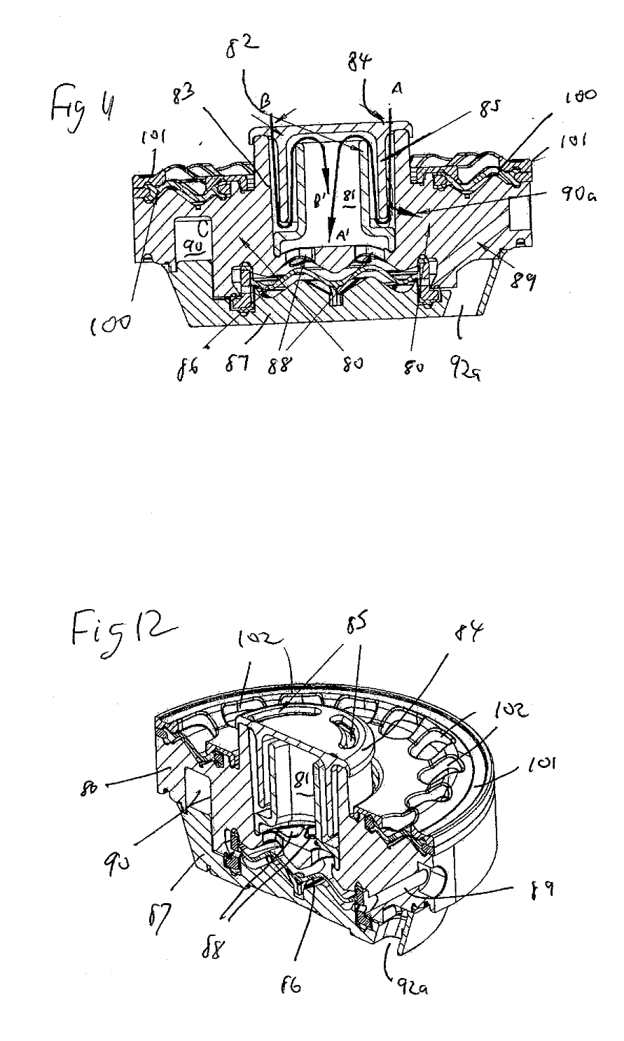

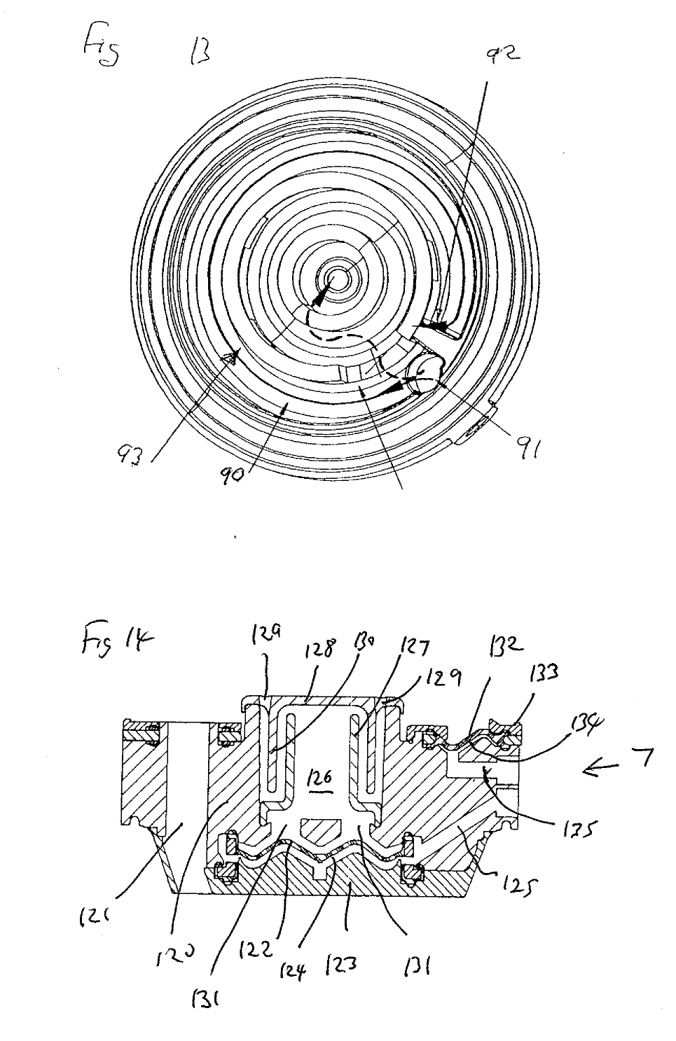

Thus, again, the effect of the diaphragm 86 may be locked off by applying a vacuum to the duct 89. As in the second embodiment, there is also a passageway 90 extending between the working and compensation chambers 9, 10, defined between the body 80 and the lower plate 87. An opening in the wall 83 of the bore 81 (the opening not being visible is FIGS. 11 and 12 but indicated by the arrow head 90a) leads to that passageway 90, that opening being shown more clearly in FIG. 13. The passageway 90 leads to an outlet 92a (in FIGS. 11 and 12, and indicated by the arrowhead 92 in FIG. 13) to the compensation chamber 10. Thus, when the flow path to the diaphragm 86 is locked off, by application of a vacuum to the duct 89, fluid flows as shown by arrow 93 in the passageway 90 between the working and compensation chambers 9, 10.

FIGS. 10 to 12 show that, in a similar way to the second embodiment, the mounting device of the third embodiment has a second diaphragm 100 (in this case an annular diaphragm), held between the body 80 and an upper plate 101. As can be seen in FIG. 12, there are openings 102 in that upper plate, to allow hydraulic fluid from the working chamber 9 to communicate with the diaphragm 100. The diaphragm 100 thus acts to separate fluid in the working chamber 9 from a gas pocket. Although not shown in FIGS. 10 to 13, that gas pocket may have a duct leading to a vacuum source, as in the second embodiment.

Thus, the behaviour of the third embodiment is similar to that of the second embodiment, and thus will not be described in more detail now.

A fourth embodiment will now be described with reference to FIG. 14. FIG. 14 shows only the partition 7 of the mounting device. Other features of the mounting device may be the same as shown in FIG. 1, 6 or 10.

In the second and third embodiments, the fluid path to the diaphragm 60 was in a branch from the passageway 62, 90 between the working and compensation chambers 9, 10. In this fourth embodiment, the duct to the diaphragm is separate from the passageway between the working and compensation chambers 9, 10, but the duct to the diaphragm is convoluted in a similar way to the third embodiment.

Thus, referring to FIG. 14, the partition 7 has a main body 120 with a passageway 121 therein which links the working and compensation chambers 9, 10. In FIG. 14, The passageway 121 Is relatively short and straight. However, it may be in the form of a spiral, or other elongate path to achieve appropriate damping characteristics. The main body 120 supports a diaphragm 122, held between the lower part of the main body 120 and a lower plate 123. An airspace 124 is defined between the diaphragm 122 and the lower body 123, with that space having a duct 125 which may lead to a vacuum source (not shown) in a similar way to the duct 89 in the third embodiment.

The main body 120 has a central bore 126 therein, with a cylindrical projection 127 extending apparently in the bore 126. An upper cap 128 is fitted over that bore 126 with openings 129 which communicate with the working chamber 9. A cylindrical projection 130 extends downwardly from the upper cap 128. Thus, the convoluted path is defined from the working chamber 9 to the diaphragm 122, via the openings 129, and around the cylindrical walls 127, 130, to the centre of the bore 126. The bore 126 communicates via openings 131 with the upper surface of the diaphragm 122.

The arrangement is thus similar to the arrangement shown in FIG. 11, with the structure providing a smaller function to the bore 81, projections 82 and 85, cap 84 and openings 85 and 88. The fluid path formed by the convolution of the duct leading from the working chamber 9 to the diaphragm 122 in this fourth embodiment gives similar effects to the corresponding fluid path in the third embodiment. However, in this fourth embodiment, that duct is wholly separate from the passageway 121, and therefore their characteristics can be designed (by suitable size and shape of the components to achieve appropriate characteristics. This is thus different from the third embodiment, as in the second and third embodiment, where the relative dimensions of the branch to the diaphragm and the passageway between the working and compensation chambers must be chosen to achieve appropriate preferential flow, which may limit the characteristics achievable.

Note that in FIG. 14, in the second and third embodiments, there may be an additional diaphragm 132 held on the main body 120 by a holding ring 133 to define an air space 134 between that diaphragm 132 and the main body. That air space 134 may also have a duct 135 leading to e.g. a vacuum source. Thus, by controlling any vacuum applied to ducts 125, 135, the diaphragms 122, 132 may be switched between vibrating and non-vibrating states in a similar way to the diaphragms of the earlier embodiments.

What is claimed is:

1. A hydraulically damped mounting device comprising:
two anchor parts connected by a deformable wall;
a working chamber enclosed between the deformable wall and a rigid partition rigidly associated with a first one of the anchor parts, the working chamber containing hydraulic fluid;
a compensation chamber for the hydraulic fluid, the compensation chamber being at least partially bounded by a second deformable wall;
a passageway between the chambers to allow fluid communication between them; and
a flexible diaphragm part acting as a barrier between the hydraulic fluid and at least one gas chamber,
wherein the passageway is formed in the rigid partition which separates the working and compensation chambers;
characterised in that:
the partition has a hollow cavity therein having opposed surfaces defining part of the passageway therebetween, each of the opposed surfaces having a projection extending therefrom towards the other of the opposed surfaces, the free end of each projection being spaced from the surface towards which it extends, the free end of each projection being closer to the surface towards which it extends than the free end of the projection extending from that surface,
whereby the projections overlap and define a convoluted path for the passageway around the projections.

2. A hydraulically damped mounting device according to claim 1, wherein either or both of said opposed surfaces have a plurality of said projections extending therefrom.

3. A hydraulically damped mounting device according to claim 1, wherein the opening from one of the working chamber and the compensation chamber to said passageway is at a radial or central position within said cavity, and the opening from the other of the working chamber and the compensation chamber to said passageway is at a peripheral position of said cavity.

4. A hydraulically damped mounting device according to claim 3, wherein the projections are cylindrical.

5. A hydraulically damped mounting device according to claim 4, wherein the cylindrical projections are concentric.

6. A hydraulically damped mounting device according to claim 1, wherein the partition is a single part, the cavity being formed therein.

7. A hydraulically damped mounting device according to claim 1, wherein the partition is formed from at least two partition parts, with the cavity being formed between those partition parts.

8. A hydraulically damped mounting device according to claim 1, further comprising evacuation means connected to said at least one gas chamber, to allow the gas therefrom to be evacuated.

9. A hydraulically damped mounting device according to claim 1, wherein the diaphragm part is annular.

10. A hydraulically damped mounting device according to claim 4, wherein the opening from one of the working chamber and the compensation chamber to said passageway is within the innermost cylindrical projection, and the opening from the other of the working chamber (9) and the compensation chamber to said passageway is outside the outermost cylindrical projection.

11. A hydraulically damped mounting device comprising:
two anchor parts connected by a deformable wall;
a working chamber enclosed between the deformable wall and a rigid partition rigidly associated with a first one of the anchor parts, the working chamber containing hydraulic fluid;
a compensation chamber for the hydraulic fluid, the compensation chamber being at least partially bonded by a second deformable wall;
a passageway between the chambers to allow fluid communication between them; and
a flexible diaphragm part acting as a barrier between the hydraulic fluid and at least one gas chamber,
wherein there is a duct for hydraulic fluid formed in the rigid partition which separates the working and compensation chambers, and supports the diaphragm part,
the partition having a hollow cavity therein having opposed surfaces defining part of the duct therebetween, each of the opposed surfaces having a projection extending therefrom towards the other of the opposed surfaces, the free end of each projection being spaced from the surface towards which it extends, the free end of each projection being closer to the surface towards which it extends than the free end of the projection extending from that surface,
the duct extending to said diaphragm part from said working chamber or said compensation chamber, the duct extending through said cavity, whereby said duct is convolted around the projections.

12. A hydraulically damped mounting device according to claim 11, wherein either or both of said opposed surfaces have a plurality of said projections extending therefrom.

13. A hydraulically damped mounting device according to claim 11, wherein the opening from said duct to said diaphragm part is at a central part of said cavity, and the opening from said duct to said working chamber or said compensation chamber is at a peripheral part of said cavity.

14. A hydraulically damped mounting device according to claim 13, wherein the projections are cylindrical.

15. A hydraulically damped mounting device according to claim 11, wherein the partition is a single part, the cavity being formed therein.

16. A hydraulically damped mounting device according to claim 11, wherein the partition is formed from at least two partition parts, with the cavity being formed between those partition parts.

17. A hydraulically damped mounting device according to claim 11, further comprising evacuation means connected to said at least one gas chamber, to allow the gas therefrom to be evacuated.

18. A hydraulically damped mounting device according to claim 11, further comprising a further diaphragm part acting as a barrier between the hydraulic fluid in the working chamber and a gas pocket.

19. A hydraulically damped mounting device according to claim 18, further comprising evacuation means connected to said gas pocket, to allow the gas therefrom to be evacuated.

20. A hydraulically damped mounting device according to claim 11, wherein the or any diaphragm part is annular.

21. A hydraulically damped mounting device according to claim 14, wherein the opening from said duct to said working chamber or said compensation chamber is outside the outermost cylindrical projection, and the opening from said duct to said diaphragm part is within the innermost cylindrical projection.

22. A hydraulically damped mounting device comprising
two anchor parts connected by a deformable wall;
a working chamber enclosed between the deformable wall and a rigid partition rigidly associated with a first one of the anchor parts, the working chamber containing hydraulic fluid;
a compensation chamber for the hydraulic fluid, the compensation chamber being at least partially bounded by a second deformable wall;
a passageway between the chamber to allow fluid communication between them; and
a flexible diaphragm part acting as a barrier between the hydraulic fluid and at least one gas chamber,
wherein the passageway is formed in the rigid partition which separates the working and compensation chambers; the partition has a hollow cavity therein having opposed surfaces each of the opposed surfaces having a projection extending therefrom towards the other of the opposed surfaces, the free end of each projection being spaced from the surface towards which it extends, the free end of each projection being closer to the surface towards which it extends than the free end of the projection extending from that surface,
wherein said passageway has a branch extending therefrom into said cavity, and from said cavity to said diaphragm part, whereby said branch of said passageway is convoluted around said projections.

23. A hydraulically damped mounting device according to claim 22, wherein either or both of said opposed surfaces have a plurality of said projections (54,55,56) extending therefrom.

24. A hydraulically damped mounting device according to claim 22, wherein the opening from said branch to said diaphragm part is at a central part of said cavity, and the opening from said branch to said working chamber or said compensation chamber is at a peripheral part of said cavity.

25. A hydraulically damped mounting device according to claim 24, wherein the projections are cylindrical.

26. A hydraulically damped mounting device according to claim 22, wherein the partition is a single part, the cavity being formed therein.

27. A hydraulically damped mounting device according to claim 22, wherein the partition is formed from at least two partition parts, with the cavity being formed between those partition parts.

28. A hydraulically damped mounting device according to claim 22, further comprising evacuation means connected to said at least one gas chamber, to allow the gas therefrom to be evacuated.

29. A hydraulically damped mounting device according to any claim 22, further comprising a further diaphragm part acting as a barrier between the hydraulic fluid in the working chamber and a gas pocket.

30. A hydraulically damped mounting device according to claim 29, further comprising evacuation means connected to said gas pocket, to allow the gas therefrom to be evacuated.

31. A hydraulically damped mounting device according to claims 22, wherein the or any diaphragm part is annular.

32. A hydraulically damped mounting device according to claim 25, wherein the opening form said branch to said working chamber or said compensation chamber is outside the outermost cylindrical projection, and the opening from said branch to said diaphragm part is within the innermost cylindrical projection.
